(19) United States
(12) Patent Application Publication
(10) Pub. No.: US 2018/0311620 A1
(43) Pub. Date: Nov. 1, 2018

(54) MULTISTAGE MEMBRANE DISTILLATION DEVICE AND METHOD FOR RECOVERING VOLATILE AND CONDENSABLE SUBSTANCE

(71) Applicant: BL TECHNOLOGIES, INC., Minnetonka, MN (US)

(72) Inventors: Xianguo YU, Shanghai (CN); Hui LEI, Shanghai (CN); Andrew Philip SHAPIRO, Malta, NY (US); Hai YANG, Shanghai (CN); Rihua XIONG, Shanghai (CN); Markus HANKE, Garching (DE); Jens RUETTEN, Garching (DE); Bernardo Alves CINELLI, Rio de Janeiro (BR); Ana COSTA, Rio de Janeiro (BR)

(21) Appl. No.: 15/739,569

(22) PCT Filed: Jul. 8, 2016
(86) PCT No.: PCT/US2016/041494

§ 371 Date: Dec. 22, 2017

(30) Foreign Application Priority Data
Jul. 8, 2015 (CN) 201510397472.X

(51) Int. Cl. B01D 61/36; B01D 53/22

(52) U.S. Cl. CPC B01D 61/364; B01D 2311/25; B01D 53/228; B01D 61/366

(57) ABSTRACT

A multistage membrane distillation device includes a plurality of membrane distillation cells each having at least one membrane. Each membrane defines a feed space at one surface thereof and a vapor space at an opposite surface thereof, and is configured to allow a part of a feed flowing in the feed space to evaporate and pass through the membrane as a vapor phase into the vapor space where the vapor phase is condensed to a distillate including a volatile and condensable substance, and the non-evaporated feed to exit the feed space as a concentrated fluid. The device further includes a fluid connection for allowing the distillate from an i^{th} cell to flow as a feed into the feed space of an (i+1)^{th} cell to produce a further distillate with a higher concentration of the volatile and condensable substance. The concentrated fluid from each cell is prevented from entering the feed space of other cells.

### BACKGROUND

The present disclosure relates to a device and method for recovering a volatile and condensable substance, and more specifically, to a multistage membrane distillation device and method for recovering a volatile and condensable substance from a fluid.

With gradual depletion of fossil fuels such as oil and natural gas, biomass has attracted significant attention as a widely distributed and renewable resource. Ethanol is an important energy resource and it can be largely produced by fermentation of sugars obtained from biomass feedstock. The most common way of separating ethanol from a fermentation solution is distillation. But distillation is usually a very energy intensive process and it may use more energy than what is available from the recovered ethanol. Therefore, there are many investigations to develop alternative, less energy-intensive techniques for the ethanol recovery. For example, extraction and extraction-distillation hybrid processes have been investigated for separating ethanol from an aqueous ethanol mixture. However, extraction involves use of solvent and may cause issues regarding solvent recovery and thus increase cost and complexity.

Therefore, it is desirable to provide new devices and methods for recovering a volatile and condensable substance from a fluid with relatively lower energy consumption.

### BRIEF DESCRIPTION

In one aspect, a multistage membrane distillation device includes a plurality of membrane distillation cells. Each of the plurality of membrane distillation cells includes at least one membrane. Each of the at least one membrane defines a feed space at one surface thereof and a vapor space at an opposite surface thereof, and is configured to allow a part of a feed flowing in the feed space to evaporate and pass through the membrane as a vapor phase into the vapor space where the vapor phase is condensed to a distillate including a volatile and condensable substance, and the non-evaporated feed to exit the feed space as a concentrated fluid. The multistage membrane distillation device further includes a fluid connection configured to allow the distillate from an i^{th} cell to flow as a feed into the feed space of an (i+1)^{th} cell to produce a further distillate having a higher concentration of the volatile and condensable substance. The concentrated fluid from each of the plurality of membrane distillation cells is prevented from entering the feed space of other membrane distillation cells.

In another aspect, a method includes passing a feed to a first membrane distillation cell of a plurality of membrane distillation cells wherein each of the plurality of membrane distillation cells includes at least one membrane. Each of the at least one membranes defines a feed space at one surface thereof and a vapor space at an opposite surface thereof, and is configured to allow a part of a feed flowing in the feed space to evaporate and pass through the membrane as a vapor phase into the vapor space where the vapor phase is condensed to a distillate including a volatile and condensable substance, and the non-evaporated feed to exit the feed space as a concentrated fluid. The distillate from an i^{th} cell is passed as a feed into the feed space of an (i+1)^{th} cell to produce a further distillate having a higher concentration of the volatile and condensable substance. A final distillate is collected from a last membrane distillation cell of the plurality of membrane distillation cells. The concentrated fluid from each of the membrane distillation cells is prevented from entering the feed space of other membrane distillation cells.

### BRIEF DESCRIPTION OF THE DRAWINGS

The above and other aspects, features, and advantages of the present disclosure will become more apparent in light of the subsequent detailed description when taken in conjunction with the accompanying drawings in which:

FIG. 1 is a schematic view of a multistage membrane distillation device including a plurality of series-connected membrane distillation cells, in accordance with one embodiment of the present disclosure.

FIG. 2 illustrates a distillate reflux design in the multistage membrane distillation device of FIG. 1, in accordance with one embodiment of the present disclosure.

FIG. 3 illustrates a specific architecture of the multistage membrane distillation device of FIG. 1.

FIG. 4 illustrates a membrane distillation cell including alternative feed spaces and vapor spaces, in which a feed flows through the feed spaces in series and distillates are refluxed from the vapor spaces to the feed spaces, in accordance with one embodiment of the present disclosure.

FIG. 5 illustrates an ethanol concentration curve and a feed flux curve for evaluating the performance of the multistage membrane distillation in an example of separating ethanol from a fermentation solution.

### DETAILED DESCRIPTION

One or more embodiments of the present disclosure will be described below. Unless defined otherwise, technical and scientific terms used herein have the same meaning as is commonly understood by one of skill in the art to which this invention belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean any, some, or all of the listed items. The use of “including,” “comprising” or “having” and variations thereof herein are meant to encompass the items listed thereafter and equivalents thereof as well as additional items.

Approximating language, as used herein throughout the specification and claims, may be applied to modify any quantitative representation that could permissibly vary without resulting in a change in the basic function to which it is related. Accordingly, a value modified by a term or terms such as “about” is not to be limited to the precise value specified. Additionally, when using an expression of “about a first value-a second value,” the about is intended to modify both values. In at least some instances, the approximating language may correspond to the precision of an instrument for measuring the value. Here, and throughout the specification and claims, range limitations may be combined and/or interchanged, such ranges are identified and include all the sub-ranges contained therein unless context or language indicates otherwise.

Embodiments of the present disclosure refer to devices and methods for recovery of a volatile and condensable substance from a fluid feed. The devices and methods involve use of novel multistage membrane distillation configurations with distillate flow design, in which a plurality of membrane distillation cells are in fluid communication along a distillate flow direction. Use of the novel multistage membrane distillation configurations can realize high recovery of volatile and condensable substances in some industrial fluids or mixture compounds, with relatively lower energy consumption. The fluids or compounds may be fermentation solutions, organic mixture compounds, waste water or biomass solutions that include volatile and condensable substances. Examples of volatile and condensable substances recoverable with said devices and methods include, but are not limited to ethanol, bioethanol, methanol, propanol, isopropanol, butanol, acetaldehyde, ethane-1,1-diethoxy, phenylethyl alcohol, ammonia, or hydrogen chloride or such kinds of materials generated in the biomass process. For the convenience of description, the volatile and condensable substances to be recovered may be referred to as “target substance” hereinafter.

As used herein, “membrane distillation” refers to a separation process, in which vapor molecules transfer through a membrane but liquid molecules are blocked by the membrane, usually driven by a partial vapor pressure difference triggered by a temperature difference. Each membrane distillation cell may include a membrane configured to allow a vapor phase to pass through from a feed space at one side of the membrane to a vapor space at the other side of the membrane but keep a liquid phase as a concentrated fluid in the feed space. In some embodiments, the membrane distillation cell may further include a condenser for condensing said vapor phase to a liquid distillate in the vapor space. The condenser may have a relatively cool surface such that the vapor phase flowing over the relatively cool surface can be condensed to a liquid distillate. Applicable membrane distillation configurations include, but are not limited to vacuum membrane distillation (VMD), air gap membrane distillation (AGMD), direct contact membrane distillation (DCMD), sweeping gas membrane distillation (SGMD).

The membrane distillation cells may be series connected. Each one of the membrane distillation cells (except the cell of the last stage) has its distillate flow to a next one of the membrane distillation cells for further distillation in order to increase concentration of the target substance in the distillate. Specifically, a distillate from the vapor space of each membrane distillation cell may flows as a feed to the feed space of a next membrane distillation cell. The membrane distillation cells are integrated in a distillate flow direction rather than a feed flow direction. The concentrated fluid exiting the feed space of a membrane distillation cell may be prevented from entering the feed space of other membrane distillation cells.

Some non-limiting examples of the multistage membrane distillation configurations in accordance with embodiments of the present disclosure will be described below in conjunction with the accompanying drawings.

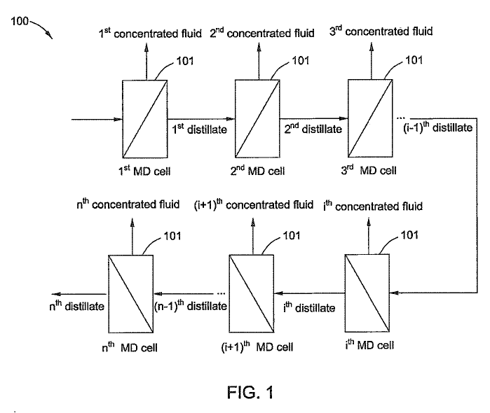

FIGS. 1-3 illustrate a multistage membrane distillation device 100 including a plurality of series-connected membrane distillation (MD) cells. The working process of the device 100 will be explained by an example of separating bioethanol from a fermentation solution. Referring to FIG. 1, the multistage membrane distillation device 100 includes a plurality of MD cells 101, the 1^{st}, 2^{nd}, 3^{rd}, . . . , i^{th}, (i+1)^{th}, . . . , n^{th} MD cells, which are in fluid communication along a distillate flow direction, wherein n is an integer greater than 2, and i is an integer greater than 1 but smaller than n. A fermentation solution (a feed) including about 8 wt % ethanol is fed into the 1^{st} MD cell, in which a first distillate including about 16 wt % ethanol is generated from the fermentation solution and the rest of the fermentation solution is outputted as a first concentrated fluid. The first distillate is fed as a feed into the 2^{nd} MD cell, in which a second distillate including about 40 wt % ethanol is generated from the first distillate and the rest of the first distillate is outputted as a second concentrated fluid, and then the second distillate from the 2^{nd} MD cell is further fed as a feed into the 3^{rd} MD cell, and so on to the MD cell of the last stage (the n^{th} MD cell). In other words, distillate from each MD cell (the i^{th} MD cell) except the last stage MD cell is fed as a feed into a next MD cell (the (i+1)^{th} MD cell) to generate a distillate including ethanol of a higher concentration. By such a configuration, the concentration of the target substance (such as ethanol of this example) in the distillate continuously increases stage by stage along the distillate flow direction.

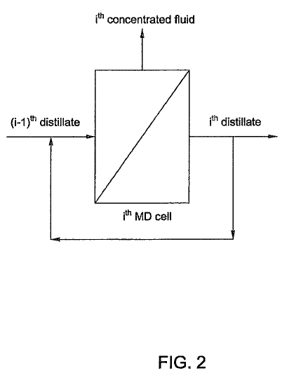

The multistage membrane distillation device 100 may have distillate reflux. The distillate from at least one of the MD cells may be partially returned back as a part of feed into the same cell or previous cells. For example, in some embodiments, as shown in FIG. 2, each MD cell (the i^{th} MD cell) in the multistage membrane distillation device 100 may have at least a part of its distillate returned back as a part of its feed. In some embodiments, at least a part of the final distillate from the last stage MD cell may be returned back as a part of feed into the MD cell of the first stage. The reflux ratio is controllable to obtain a final distillate with a relatively higher concentration of the target substance.

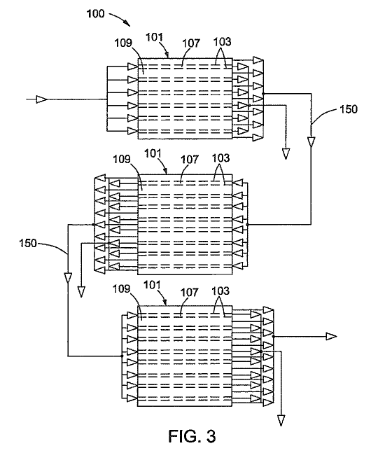

FIG. 3 shows a specific architecture of the multistage membrane distillation device 100. Each of the MD cells 101 includes a plurality of parallel-arranged hydrophobic membranes 103. The parallel-arranged hydrophobic membranes 103 define alternative feed spaces 107 and vapor spaces 109. A feed such as a feedstock like a fermentation solution or a middle-stage distillate enters and runs through in the feed spaces 107. As the feed progresses in the feed spaces 107, a part of the feed evaporates under influence of available heat as a vapor phase which passes through the membranes 103 into adjacent vapor spaces 109 and is condensed to a distillate in each of the adjacent vapor spaces 109, while the non-evaporated feed exits the feed spaces 107 as a concentrated fluid. The concentrated fluid is prevented from entering the feed space 107 of any other MD cells and it may be discharged or transported for other applications. The distillate from each MD cell 101 (except the MD cell of the last stage) is led via a fluid connection 150 to a next MD cell 101, in which it enters and runs through in the feed spaces 107 and is further converted into a distillate and a concentrated fluid.

As for each MD process stage in the device shown in FIGS. 1-3, the feed may be preheated to about 40˜70° C. before it is pumped into the MD cell for separation. During the MD process, a vapor phase including bioethanol and water penetrate through the hydrophobic membrane into the vapor space and a distillate with a bioethanol concentration higher than the feed is obtained in the vapor space. It should be noted that this example of separating bioethanol from a fermentation solution is merely illustrative and is non-limiting, the device and method described herein in conjunction with FIGS. 1-3 are applicable to recovery of other volatile and condensable substances from other fluids or compounds.

Moreover, the MD cell may have different configurations. In some embodiments, the MD cell may include a condenser for condensing the vapor phase to the distillate. In some embodiments, the MD cell may be configured to reflux the distillate from at least one of its vapor spaces as a feed to at least one of its feed spaces.

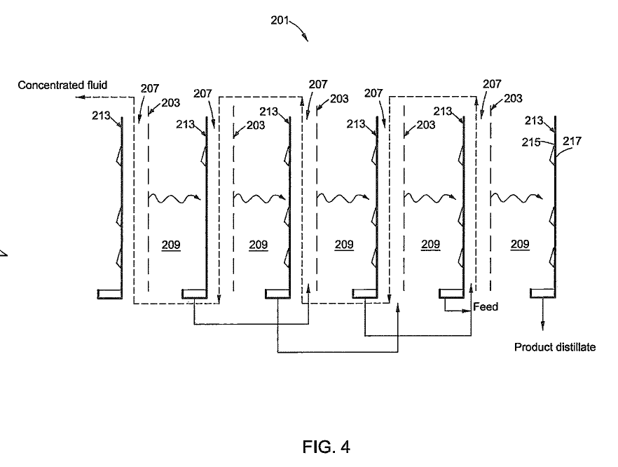

For example, FIG. 4 illustrates a MD cell 201 with a distillate reflux configuration. The MD cell 201 includes a plurality of membranes 203 and a plurality of condensers 213, which are alternatively arranged to provide alternative feed spaces 207 and vapor spaces 209. Each of the condensers 213 forms a non-porous separation between the feed and distillate, and has a cooling surface (relatively cool surface) 215 with a relatively lower temperature for condensing the vapor phase to give the distillate, and a negative surface 217 opposite to the cooling surface 215. As for each membrane 203, there is a feed space 207 between one surface of the membrane and the cooling surface 215 of the condenser 213 adjacent to that surface of the membrane, and there is a vapor space 209 between an opposite surface of the membrane and the negative surface 217 of the condenser 213 adjacent to that opposite surface of the membrane.

As illustrated in FIG. 4, in the MD cell 201, the feed flows through the plurality of feed spaces 207 in series and distillates from at least some of the vapor spaces 209 are refluxed to upstream feed spaces 207. In the embodiment as illustrated in FIG. 4, there are five membranes 203 and six condensers 213, which provide five feed spaces 207 and five vapor spaces 209. The feed flows through the 1^{st}, 2^{nd}, 3^{rd}, 4^{th} and 5^{th} feed spaces in sequence. The distillate from the 5^{th} vapor space is refluxed to the 3^{rd} feed space, the distillate from the 4^{th} vapor space is refluxed to the 2^{nd} feed space, and the distillate from the 3^{rd} vapor space is refluxed to the 1^{st} feed space. Through such a reflux configuration, the concentration of the target substance in the distillate increases stage by stage, and a product distillate (the final distillate from the 1^{st} vapor space) may include a high concentration of the target substance, for example, about 40 wt % of ethanol.

In some embodiments, the MD cell 201 may be series connected to form a multistage membrane distillation device like the device 100 described herein above. For example, the final distillate from the MD cell 201 may be passed as a feed to the feed space of another MD cell like the MD cell 101 or the MD cell 201.

The multistage membrane distillation cell integrated in a distillate flow direction as described herein above is capable of efficiently recovering a volatile and condensable target substance from a mixture, and a relatively high recovery ratio can be achievable at a relatively low operation temperature, for example, from about 40° C. to about 70° C., compared with traditional thermal distillation processes. Moreover, the lower operation temperature reduces the requirements for components of the MD device. The components may be made from anticorrosion plastic materials, which cost much less than stainless steel for manufacturing the traditional MD device.

### Example

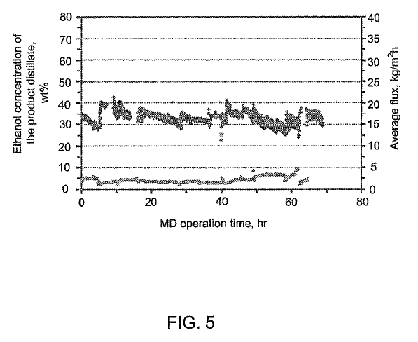

In this example, a multistage MD device like the device 100 was used to separate ethanol (CH₃CH₂OH) from a fermentation solution including about 10 wt % of ethanol, and the MD performance is evaluated. As shown in FIG. 5, throughout an operation time of about 70 hours, a product distillate including about 30-40 wt % of ethanol can be continuously achieved. The average feed flux was kept at about 2˜5 Kg/m² h during the MD process. It can be seen that, the multistage MD device and method is quite efficient in recovering a volatile and condensable substance such as ethanol from a fluid such as an aqueous ethanol mixture.

The invention may be embodied in other specific forms without departing from the spirit or essential characteristics thereof. The foregoing embodiments are therefore to be considered in all respects as illustrative rather than limiting on the invention described herein. The scope of embodiments of the invention is thus indicated by the appended claims rather than by the foregoing description, and all changes that come within the meaning and range of equivalency of the claims are therefore intended to be embraced therein.

What is claimed is:

1. A multistage membrane distillation device, comprising:
a plurality of membrane distillation cells, each comprising at least one membrane, wherein each of the at least one membranes defines a feed space at one surface thereof and a vapor space at an opposite surface thereof, and is configured to allow a part of a feed flowing in the feed space to evaporate and pass through the membrane as a vapor phase into the vapor space where the vapor phase is condensed to a distillate comprising a volatile and condensable substance, and the non-evaporated feed to exit the feed space as a concentrated fluid; and
a fluid connection configured to allow the distillate from an i^{th} cell to flow as a feed into the feed space of an (i+1)^{th} cell to produce a further distillate having a higher concentration of the volatile and condensable substance,
wherein the concentrated fluid from each of the plurality of membrane distillation cells is prevented from entering the feed space of other membrane distillation cells.

2. The device according to claim 1, wherein each of the plurality of membrane distillation cells further comprises a condenser for condensing the vapor phase to the distillate.

3. The device according to claim 1, wherein each of the plurality of membrane distillation cells comprises a plurality of membranes arranged in parallel to provide alternative feed spaces and vapor spaces, wherein the feed flows in parallel through the feed spaces of the each of the plurality of membrane distillation cell.

4. The device according to claim 3, wherein each of the plurality of membrane distillation cells further comprises a plurality of condensers each having a cooling surface and a negative surface opposite to the cooling surface, wherein the membranes and the condensers are alternatively arranged and wherein the distillate spaces are formed between the membranes and the cooling surfaces of the condensers and the feed spaces are formed between the membranes and the negative surfaces of the condensers.

5. The device according to claim 1, wherein each of the plurality of membrane distillation cells comprises a plurality of membranes arranged in parallel to provide alternative feed spaces and vapor spaces, wherein the feed flows through the feed spaces of the each of the plurality of membrane distillation cell in series.

6. The device according to claim 5, wherein within each of the plurality of membrane distillation cell, distillate from at least one of the vapor spaces is refluxed to at least one of the feed spaces.

7. The device according to claim 5, wherein each of the plurality of membrane distillation cells further comprises a plurality of condensers each having a cooling surface and a negative surface opposite to the cooling surface, wherein the membranes and the condensers are alternatively arranged and wherein the distillate spaces are formed between the membranes and the cooling surfaces of the condensers and the feed spaces are formed between the membranes and the negative surfaces of the condensers.

8. The device according to claim 1, wherein the membrane distillation cell is selected from the group consisting of vacuum membrane distillation devices, air gap membrane distillation devices, direct contact membrane distillation devices, and sweeping gas membrane distillation devices.

9. The device according to claim 1, wherein the fluid is selected from the group consisting of fermentation solutions, organic mixture compounds, waste water and biomass solutions that comprise the volatile and condensable substance.

10. The device according to claim 1, wherein the volatile and condensable substance comprises ethanol, bioethanol, methanol, propanol, isopropanol, butanol, acetaldehyde, ethane-1,1-diethoxy, phenylethyl alcohol, ammonia, hydrogen chloride or a combination thereof.

11. A method, comprising:
passing a feed to a first membrane distillation cell of a plurality of membrane distillation cells, wherein each of the plurality of membrane distillation cells comprises at least one membrane defining a feed space at one surface thereof and a vapor space at an opposite surface thereof and configured to allow a part of a feed flowing in the feed space to evaporate and pass through the membrane as a vapor phase into the vapor space where the vapor phase is condensed to a distillate comprising a volatile and condensable substance and the non-evaporated feed to exit the feed space as a concentrated fluid;
passing the distillate from an i^{th} cell as a feed into the feed space of an (i+1)^{th} cell to produce a further distillate having a higher concentration of the volatile and condensable substance; and
collecting a final distillate from a last membrane distillation cell of the plurality of membrane distillation cells;
wherein the concentrated fluid from each of the membrane distillation cells is prevented from entering the feed space of other membrane distillation cells.

12. The method according to claim 11, wherein each of the plurality of membrane distillation cells further comprises a condenser for condensing the vapor phase to the distillate.

13. The method according to claim 11, wherein each of the plurality of membrane distillation cells comprises a plurality of membranes arranged in parallel to provide alternative feed spaces and vapor spaces, wherein the feed flows in parallel through the feed spaces of the each of the plurality of membrane distillation cell.

14. The method according to claim 13, wherein each of the plurality of membrane distillation cells further comprises a plurality of condensers each having a cooling surface and a negative surface opposite to the cooling surface, wherein the membranes and the condensers are alternatively arranged and wherein the distillate spaces are formed between the membranes and the cooling surfaces of the condensers and the feed spaces are formed between the membranes and the negative surfaces of the condensers.

15. The method according to claim 11, wherein each of the plurality of membrane distillation cells comprises a plurality of membranes arranged in parallel to provide alternative feed spaces and vapor spaces, wherein the feed flows through the feed spaces of the each of the plurality of membrane distillation cell in series.

16. The method according to claim 15, further comprising refluxing distillate from at least one of the vapor spaces to at least one of the feed spaces within each of the plurality of membrane distillation cell.

17. The method according to claim 15, wherein each of the plurality of membrane distillation cells further comprises a plurality of condensers each having a cooling surface and a negative surface opposite to the cooling surface, wherein the membranes and the condensers are alternatively arranged and wherein the distillate spaces are formed between the membranes and the cooling surfaces of the condensers and the feed spaces are formed between the membranes and the negative surfaces of the condensers.

18. The method according to claim 11, wherein the membrane distillation cell is selected from the group consisting of vacuum membrane distillation devices, air gap membrane distillation devices, direct contact membrane distillation devices, and sweeping gas membrane distillation devices.

19. The method according to claim 11, wherein the fluid is selected from the group consisting of fermentation solutions, organic mixture compounds, waste water and biomass solutions that comprise the volatile and condensable substance.

20. The method according to claim 11, wherein the volatile and condensable substance comprises ethanol, bioethanol, methanol, propanol, isopropanol, butanol, acetaldehyde, ethane-1,1-diethoxy, phenylethyl alcohol, ammonia, hydrogen chloride or a combination thereof.
